(19) United States
(12) Patent Application Publication
(10) Pub. No.: US 2007/0174803 A1
(43) Pub. Date: Jul. 26, 2007

(54) Method for concurrent search and select of routing patterns for a routing system

(75) Inventors: Jung-Cheun Lien, San Jose, CA (US); Minchen Zhao, Palo Alto, CA (US)

Correspondence Address: BIRCH STEWART KOLASCH & BIRCH, PO BOX 747, FALLS CHURCH, VA, 22040-0747, US

(73) Assignee: LIZOTECH, INC.

(21) Appl. No.: 11/651,458

(22) Filed: Jan. 10, 2007

Related U.S. Application Data
(60) Provisional application No. 60/760,696, filed on Jan. 20, 2006.

(51) Int. Cl. G06F 17/50

(52) U.S. Cl. 716/12

(57) ABSTRACT

A method for concurrent search and select of routing patterns for a routing system is provided. The provided method introduces a metric for indicating the goodness of a routing pattern for guiding the selection of search engine at the route finding stage. Next, the method explores routes based on a plurality of feasible routing track segments that represent the longest continuous span of possible routes on a routing layer. Next, the preferred routing patterns can be selected. After that, the method goes to find one or more routing violations and then avoid the routing violations. Furthermore, the avoidance of the routing violation(s) can be implemented by reducing the length of the feasible routing track segment, or removing portion of a routed segment running in parallel and adjacent track(s) of the feasible routing track segment.

### CROSS REFERENCE TO RELATED PROVISIONAL APPLICATION

This application claims the benefit under 35 USC 119(e) of U.S. Provisional Application No. 60/760,696, filed Jan. 20, 2006, the contents of all of which are incorporated herein in their entirety.

### BACKGROUND OF THE INVENTION

1. Field of the Invention

The present invention relates to a method for concurrent search and select of routing patterns for a routing system, more particularly, a metric is introduced into a search engine to find the route.

2. Description of Related Art

### BACKGROUNDS

### (1) Introduction to IC Routing Problem

An integrated circuit (IC) usually consists of a functional portion and an interconnect portion. The functional portion includes a set of functional elements which can be transistors, logic gates or functional blocks. The interconnect portion includes a set of metal wires and vias that connect the input and output terminals of functional elements to form the intended function of the circuit. To implement an IC, a designer must suitably place all functional elements, which can be in millions of gates, and route all the required connections specified in a netlist. To ensure the layout circuit works properly, the designer must do various analyses such as timing, signal integrity and power consumption on the circuit. A layout database must be adopted to pass a physical verification such as Design Rule Checks (DRC) before being signed-off and sent to mask shop for manufacturing. Usually, EDA (Electronic Design Automation) tools are available to help designers do these tasks automatically.

For circuits implemented in advanced process technology (0.13 um and below), the layout database must go through RET (Resolution Enhancement Technologies) steps before sending it to the mask shop. The most common step in RET is called Optical Proximity Correction (OPC), where small geometries are added to the layout to ensure that the intended design shapes are projected onto the wafer as closely as possible.

After that, a router can connect all terminals specified in a placed netlist automatically. To connect all terminals of a given net, the router can use either one or more routing layers. The routing layers usually are metals. Switching between routing layers can be done by using vias. One or more vias can be inserted to allow signal to switch from one layer to any other layer. It's possible for a terminal signal to go through several layers to reach its destination.

There also exists areas called blockage that router must avoid. The blockage can also be in one or more routing layers. Design rules are used to guide the use of vias, blockage, metal lines width, length and spacing among them. Metal pitch refers to how close two metal lines can run in parallel. A complete routing not only has to finish all required connection specified in the netlist but also have to ensure the result is DRC clean.

Routers can be classified into two types, namely grid or gridless depending on whether a routing grid system is followed in the routing process. A grid router imposes a two dimensional grid system on routing layers, and all vias and metal lines used by the router are on the grid. In contrast, the gridless router doesn't assume such a routing grid, and the gridless router runs two metal lines at any spacing as long as the design rules are met. It is obvious that the grid router can run much faster than gridless router due to its limited searching space.

### (2) Violations

A layout design is usually required to satisfy many conditions including but not limited to area, width, length, overlap, spacing density and via doubling. These conditions are usually targeted at various aspects of IC design such as design rules, design-for-manufacturing (DFM) recommendation, critical Area/defect/yield limiting patterns, resistance, capacitance, delay and timing variations resulting from above-mentioned Optical Proximity Correction (OPC) and Resolution Enhancement Technologies (RET), Chemical Mechanical Planarization (CMP), lithography and other processing steps.

### RELATED ART

Referring to U.S. Pat. No. 6,917,847, the above-mentioned design-for-manufacturing technologies enable designers to verify and optimize layouts in digital and custom IC designs while providing a reliable way to achieve manufacturing sign-off before tape-out.

About the mentioned timing violation, please refer to a system and method for reducing timing violations due to crosstalk in an integrated circuit (IC) design of U.S. Pat. No. 7,069,528. As IC geometries have become smaller, crosstalk has increasingly caused problems in IC design. Crosstalk occurs when two signals become partially superimposed on each other due to electromagnetic (inductive) or electrostatic (capacitive) coupling between the conductors carrying those signals. The crosstalk often increases or decreases the delays within a circuit, and these varied delays can in turn lead to timing violations. U.S. Pat. No. 7,069,528 provides the method having a first step to detect the timing violation in a timing path, and a further step to remove the wire coupling two nodes included in the timing path, and a step to route a new wire between the two nodes. The method further has the steps for calculating timing information and selecting the wire for removal based on the timing information.

In the conventional arts, the detection of non-preferred routing pattern is done after the routing is completed. Furthermore, a correction/optimization step is required to remove non-preferred routing patterns.

### SUMMARY OF THE DISCLOSURE

The prior arts doing the layout optimization/correction techniques by layout designers is to remove the non-preferred routing patterns, and the detection thereof is done after the routing is completed. The present invention provides a remarkable method for concurrent search and select of routing patterns for a routing system, which introduces a metric to indicate the goodness of a routing pattern for guiding the selection of search engine at the route finding stage.

According to the preferred embodiment of the present invention, the method provides a first step of indicating goodness of one or more routing patterns. The method further has a step of exploring routes based on a plurality of feasible routing track segments that represent the longest continuous span of possible routes on a routing layer. Next, the method goes to select one or more preferred routing patterns, wherein the routing pattern is computed and used to guide the preferred routing pattern(s) selection. Next, method further has a step of finding one or more routing violations by analyzing the routing pattern(s). After that, the method can avoid the routing violations as the subject matter provided by the applicant.

In the preferred embodiment of the present invention, the method includes a first step of indicating goodness of one or more routing patterns by means of a metric. Next, the method performs a step of exploring routes based on a plurality of feasible routing track segments that represent the longest continuous span of possible routes on a routing layer by means of a search engine. Further, the method goes to a step of selecting one or more preferred routing patterns in accordance with the search engine, wherein the routing pattern is computed and used to guide the preferred routing pattern(s) selection;

finding one or more routing violations by a step of computing the metrics of models. After that, the method can avoid the routing violations.

Furthermore, the mentioned layout violation is an undesirable routing pattern that violates rules. The rules include 1) Design Rules; 2) Design-for-Manufacturing Recommendations; 3) Critical Area/Defect/Yield limiting patterns; and 4) Resistance, Capacitance, Delay and timing variations resulted from Optical Proximity Correction (OPC), Resolution Enhancement Technologies (RET), Chemical Mechanical Planarization (CMP), and lithography.

Furthermore, the routing violation(s) can be avoided by means of the step of reducing the length of the feasible routing track segment, or removing portion of a routed segment running in parallel and adjacent track(s) of the feasible routing track segment.

### BRIEF DESCRIPTION OF DRAWINGS

The present invention will be readily understood by the following detailed description in conjunction with accompanying drawings, in which:

FIG. 1 depicts a scenario of where a router searches for the routing option;

FIG. 2 depicts a solution of avoiding the possible a routing violation of the present invention;

FIG. 3 depicts another solution of avoiding the possible routing violation of the present invention;

FIG. 4 shows a schematic diagram of the present invention for avoiding the possible routing violation;

FIG. 5 shows a schematic diagram of the present invention for avoiding the possible routing violation;

FIG. 6 shows a schematic diagram of the present invention for avoiding the possible routing violation;

FIG. 7 shows a flowchart for the method of the preferred embodiment of the present invention.

### DETAILED DESCRIPTION OF THE PREFERRED EMBODIMENTS

The present invention is directed towards a method for concurrent search and select of routing patterns for a routing system. For further understanding of the invention, please refer to the following detailed description illustrating the embodiments and examples of the invention. However, one of ordinary skill in the art will realize that the invention may be practiced without the use of these specific details. In other instances, well-known structures and devices are shown in block diagram form in order not to obscure the description of the invention with unnecessary detail.

The method provided by the present invention is different from the conventional technologies which perform the correction or optimization procedures by means of removal of non-preferred routing patterns after finishing routing process.

Differently, the present invention details the method for a routing system that can concurrently search and select preferred routing patterns. More particularly, a metric is introduced into indicating the goodness of a routing pattern, which is computed and used to guide the preferred routing patterns selection. Moreover, the selection process is made in accordance with a search engine at the route finding stage. Consequently, the finished routes thus are free of undesirable routing patterns.

The routing system of the present invention provides a search engine to find routes for the routing process. When the invention performs the search process, the search engine explores routes based on some feasible segments. These feasible segments can be partially or entirely used in the routes, wherein the feasible segments represent the longest continuous span of possible routes on the routing layer. The present invention features that the router can determine if it uses part or all of the feasible segments for a route during the routing process. Furthermore, the router can also assume an underlying grid system for finding possible routes, in the meantime, all the feasible segments are running on grid either in horizontal or vertical direction. Especially, this underlying grid used for the routing layer doesn't need to fix the routing throughout. It is possible to re-formulate or re-size the grid during the routing process.

A layout violation is an undesirable routing pattern that violates rules, recommendations and/or guidelines in one or more areas including but not limited to:

1. Design Rules,

2. Design-for-Manufacturing Recommendations,

3. Critical Area/Defect/Yield limiting patterns, and

4. Resistance, Capacitance, Delay and timing variations resulted from Optical Proximity Correction (OPC), Resolution Enhancement Technologies (RET), Chemical Mechanical Planarization (CMP), lithography and other processing steps.

By the regular skilled person in the art, the layout violation can be found by analyzing the routing patterns and/or by computing some metrics of some models and/or simply by following a set of rules and guidelines.

The method of the present invention provides the scheme having layout optimization/correction or layout violation avoidance for the routing system, especially the scheme can be performed with the formulated grid during the search process. The features disclosed in the preferred embodiment of the invention include:

1. a routing grid is imposed,

2. avoidance/correction are done on grid, and

3. avoidance/correction methods are deployed partially on the router searching engine for routes selection. In a preferred embodiment, this engine is equipped with a layout correction/optimization means, and the present method makes correction in accordance with the grid system by means of the search engine.

Here shows some avoidance schemes of the preferred embodiments of the present invention thereinafter:

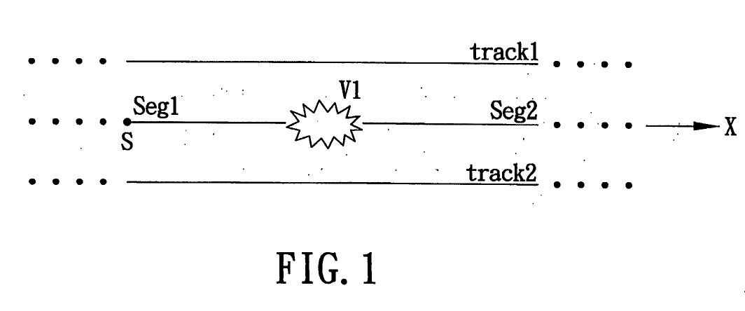

FIG. 1 depicts a scenario of where a router searches for the routing options. In this embodiment, the point S is where the router starts from, then the router expands paths in x (horizontal) direction. More, both adjacent tracks including the tracks above (track 1) and below (track 2) are occupied. In this case, the right hand side segment (Seg2) of the track has been occupied. The longest span the router processes is shown as Seg1 which is a feasible segment. After that, a possible violation region (v1) has been taken out of the feasible segment.

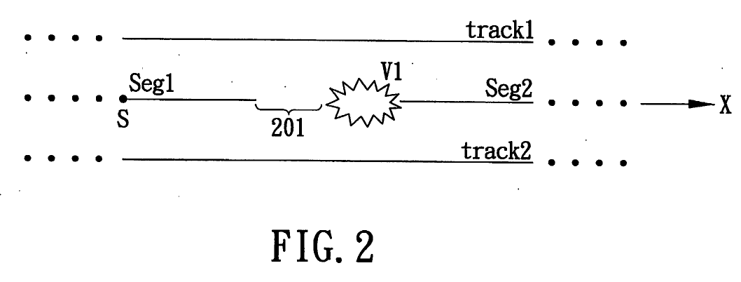

FIG. 2 depicts a solution of avoiding the possible a routing violation. The point S is also where the router starts from, and the router also expands the paths in x direction. In this embodiment, the feasible segment Seg1 has been shortened, and more space (201) between the segments Seg1 and Seg2 has been added to avoid the violation region (v1). Particularly, the feasible segment Seg1 and Seg2 stay on grid.

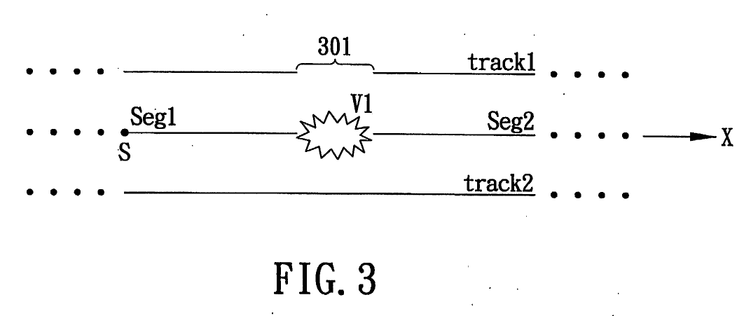

Reference is made to FIG. 3, which depicts another solution of avoiding the possible routing violation. This diagram shows part of the adjacent routed track (for example, the track 1) has been deleted to have more space (301) for avoiding the routing violation (v1).

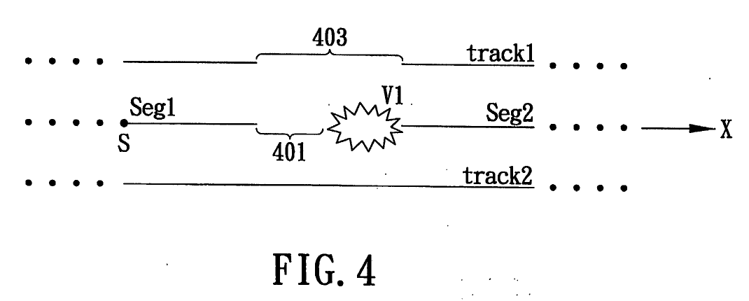

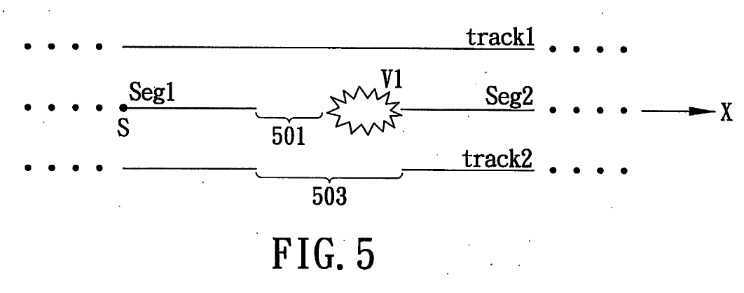

For meeting the subject matter of the present invention, both FIG. 4 and FIG. 5 show the solution of combining the schemes of FIG. 2 and FIG. 3. In FIG. 4, the point S is also where the router starts from, and the router also expands the paths in x direction in this case. The feasible segment Seg1 has been shortened and left a space (401) thereon, and part of the adjacent routed track (track 1) has been deleted to have a space (403) for avoiding the routing violation (v1). In FIG. 5, that also shows that spaces have been added in both horizontal and vertical direction. In this case, besides the feasible segment Seg1 has been shortened to have a space (501), the partial segment of the adjacent routed track (track 2) has been deleted to have a space (503) for avoiding the routing violation (v1).

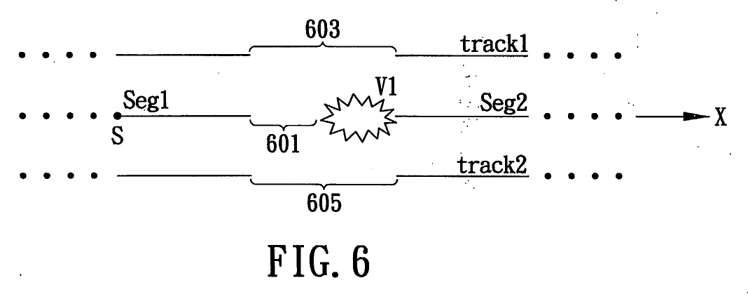

For avoiding the possible routing violation (v1), spaces have been added in both horizontal and vertical directions near the routing violation (v1). FIG. 6 depicts a solution to avoid the possible routing violation. Space (601) has been generated in left feasible segment (Seg1) since the feasible segment has been shorten. Moreover, parts of both the track 1 and track 2 have been deleted for leaving the spaces thereon. The spaces (603, 605) added on the adjacent tracks are above and below the violation region (v1).

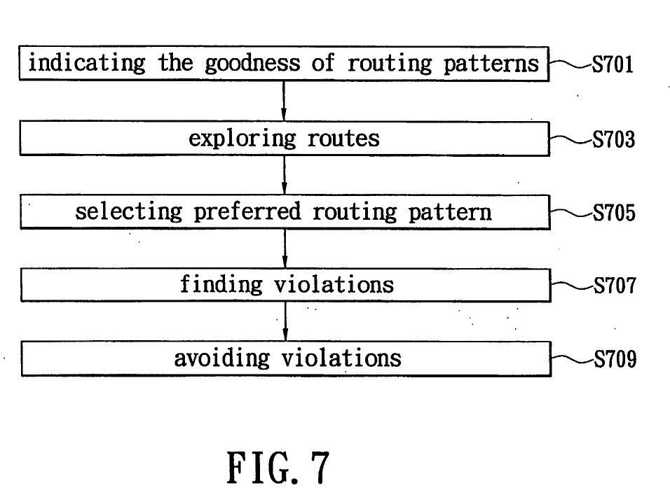

According to the above schemes, the method for concurrent search and select of routing patterns of the present invention includes the steps shown in FIG. 7.

To begin, the routing system of the present invention provides a first step for determining the goodness of routing patterns, in the preferred embodiment, a metric or the like is used to indicate or determine the goodness of routing patterns (step S701);

After the step for indicating the goodness of the routing patterns, a search engine is introduced into exploring and finding routes based on some feasible routing track segments, which represent the longest continuous span of possible routes on the routing layer (step S703).

Next, the routing patterns are computed and used to guide the preferred routing patterns selection, and the preferred routing patterns are selected (step S705).

Particularly, this decision of selection is made in accordance with the search engine at the route finding stage. Since the preferred embodiment is implemented in a grid-based routing system, the grid system can further be re-formulated or re-sized during this routing process.

Next, the layout violation can be found by analyzing the routing patterns and/or by computing some metrics of some models by above-mentioned rules and guidelines (step S707).

After that, the step goes to avoid the routing violations (step S709). The mentioned search engine can be used to avoid the routing violations by using one or the combination of the above-mentioned schemes shown in FIGS. 1-6. Those schemes can be implemented by the step of reducing the length of the feasible segment, or the step of removing portion of a routed segment running in parallel and adjacent track(s) of the feasible routing track segment.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for concurrent search and select of routing patterns for a routing system, comprising:
indicating goodness of one or more routing patterns;
exploring routes based on a plurality of feasible routing track segments that represent the longest continuous span of possible routes on a routing layer;
selecting one or more preferred routing patterns, wherein the routing pattern is computed and used to guide the preferred routing pattern(s) selection;
finding one or more routing violations by analyzing the routing pattern(s); and
avoiding the routing violations.

2. The method of claim 1, wherein a metric is used for the step of indicating the goodness of routing pattern(s).

3. The method of claim 1, wherein a search engine is used for the step of exploring the routes.

4. The method of claim 1, wherein the decision of selection is made in accordance with a search engine in the step of selecting the routing pattern(s).

5. The method of claim 1, wherein the method is implemented in a grid-based routing system.

6. The method according to claim 5, wherein the grid system is able to be re-formulated during this routing process.

7. The method according to claim 5, wherein the grid system is able to be re-sized during this routing process.

8. The method of claim 1, wherein the step of analyzing the routing pattern(s) for finding routing violation(s) by means of computing the metrics of models.

9. The method according to claim 8, wherein the layout violation is an undesirable routing pattern that violates rules having:
1) Design Rules;
2) Design-for-Manufacturing Recommendations;
3) Critical Area/Defect/Yield limiting patterns; and
4) Resistance, Capacitance, Delay and timing variations resulted from Optical Proximity Correction (OPC), Resolution Enhancement Technologies (RET), Chemical Mechanical Planarization (CMP), and lithography.

10. The method of claim 1, wherein the step of avoiding the violation(s) is implemented by the step of reducing the length of the feasible routing track segment.

11. The method of claim 1, wherein the step of avoiding the violation(s) is implemented by the step of removing portion of a routed segment running in parallel and adjacent track(s) of the feasible routing track segment.

12. The method of claim 1, wherein the feasible routing track segment is partially or entirely used in a route.

13. The method of claim 1, wherein the routing track(s) are continuous and running on grid.

14. A method for concurrent search and select of routing patterns for a routing system, comprising:
indicating goodness of one or more routing patterns by means of a metric;
exploring routes based on a plurality of feasible routing track segments that represent the longest continuous span of possible routes on a routing layer by means of a search engine;
selecting one or more preferred routing patterns in accordance with the search engine, wherein the routing pattern is computed and used to guide the preferred routing pattern(s) selection;
finding one or more routing violations by a step of computing the metrics of models; and
avoiding the routing violations.

15. The method of claim 14, wherein the method is implemented in a grid-based routing system.

16. The method according to claim 15, wherein the grid system is able to be re-formulated during this routing process.

17. The method according to claim 15, wherein the grid system is able to be re-sized during this routing process.

18. The method according to claim 14, wherein the layout violation is an undesirable routing pattern that violates rules having:
1) Design Rules;
2) Design-for-Manufacturing Recommendations;
3) Critical Area/Defect/Yield limiting patterns; and
4) Resistance, Capacitance, Delay and timing variations resulted from Optical Proximity Correction (OPC), Resolution Enhancement Technologies (RET), Chemical Mechanical Planarization (CMP), and lithography.

19. The method of claim 14, wherein the step of avoiding the violation(s) is implemented by the step of reducing the length of the feasible routing track segment.

20. The method of claim 14, wherein the step of avoiding the violation(s) is implemented by the step of removing portion of a routed segment running in parallel and adjacent track(s) of the feasible routing track segment.

21. The method of claim 14, wherein the feasible routing track segment is partially or entirely used in a route.

22. The method of claim 14, wherein the routing track(s) are continuous and running on grid.
